(19) United States
(12) Patent Application Publication
(10) Pub. No.: US 2008/0140784 A1
(43) Pub. Date: Jun. 12, 2008

(54) Multiple Originators in an Electronic Message

(75) Inventors: Patrick J. O'Sullivan, Dublin (IE); Edith H. Stern, Yorktown Heights, NY (US); Robert C. Weir, Westford, MA (US); Barry E. Willner, Briarcliff Manor, NY (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/608,851

(22) Filed: Dec. 11, 2006

(51) Int. Cl. G06F 15/16

(52) U.S. Cl. 709/206

(57) ABSTRACT

A plurality of senders can be specified for a message. A message associated with a first sender can be created. A second sender can be associated with the message. The first sender and the second sender can be included in an originator portion of the message. The message can be send to a recipient.

### BACKGROUND OF THE INVENTION

Conventional electronic mail systems allow messages to be sent from a sender to one or more recipients. The recipients can be specified by including the address, or other identifier, for each recipient within a destination field, e.g., a “to” field, a “carbon copy” field, or a “blind copy” field, of the message.

Recipients are included in the carbon copy field of messages for any number of reasons. For example, one reason is to make the copied party aware of the communication being sent. Another reason is to make the recipient aware that others, i.e., the persons being copied on the message, are also aware of the message. It is not unusual to send a message to a recipient and carbon copy a supervisor of the recipient or another colleague. In doing so, the sender attempts to motivate the recipient to perform a task to a greater degree than had the supervisor not been copied on the message. By copying the manager, the sender tries to imply that the manager approves of the message.

With the significant volume of messages exchanged in modern business environments, the fact that an individual is carbon copied on a message may not have the impact that was originally intended by the sender. The mere inclusion of a manager, for example, in the carbon copy field of an electronic mail, does not indicate to the recipient, with any certainty, that the manager actually agrees with the content of the message, has approved of the message, or is even aware that the message was sent.

### BRIEF SUMMARY OF THE INVENTION

The present invention relates to a method of specifying a plurality of senders for a message. The method can include creating a message associated with a first sender, associating a second sender with the message, and specifying the first sender and the second sender in an originator portion of the message. The method further can include sending the message to a recipient.

The present invention also relates to a system for specifying a plurality of senders for a message. The system can include a first messaging client associated with a first sender and a second messaging client associated with a second sender. The first messaging client can create a message from the first sender and associate the message with the second sender. The first messaging client can send the message to the second messaging client and the second messaging client can provide approval of the message. A messaging server can provide the message to a recipient. The message can specify the first sender and the second sender in an originator portion of the message.

The present invention also relates to a computer program product including a computer-usable medium having computer-usable program code that, when executed by an information processing system, can perform the various steps and/or functions disclosed herein.

### BRIEF DESCRIPTION OF THE SEVERAL VIEWS OF THE DRAWINGS

FIG. 1 is a block diagram illustrating a system in accordance with one aspect of the present invention.

FIG. 2 is a view of a user interface for presenting a message in accordance with another aspect of the present invention.

FIG. 3 is a view of a user interface in accordance with another aspect of the present invention.

FIG. 4 is a view of a user interface for presenting a message in accordance with another aspect of the present invention.

FIG. 5 is a flow chart illustrating a method of generating an electronic message having multiple senders in accordance with another aspect of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment, including firmware, resident software, micro-code, etc., or an embodiment combining software and hardware aspects that may all generally be referred to herein as a “circuit”, “module”, or “system”.

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention relates to a messaging system that can specify multiple senders, or originators, for a given message. A plurality of senders can be associated with a message, which can be distributed among the senders for approval. Once each sender provides approval, the message can be sent to the recipient. The message that is sent will specify each of the senders in the “from” field or originator portion of the message. When the message is presented within a messaging client of the recipient, the message will specify each sender in the “from” field, thereby indicating to the recipient that the message actually was sent from, and approved by, each sender.

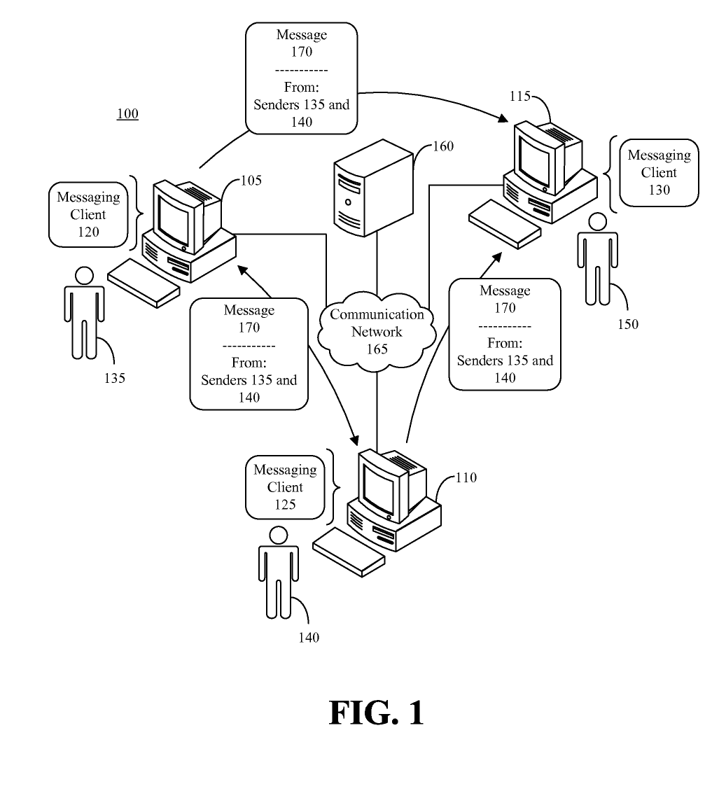

FIG. 1 is a block diagram illustrating a system 100 in accordance with one aspect of the present invention. The system 100 can include a plurality of information processing systems 105, 110, and 115, and a messaging server 160. Each of the information processing systems, 105-115, e.g., computer systems, and the messaging server 160 can be communicatively linked via a communication network 165.

The communication network 165 can be implemented as, or include, without limitation, a WAN, a LAN, the Public Switched Telephone Network (PSTN), the Web, the Internet, and one or more intranets. The communication network 165 further can include one or more wireless networks, whether short or long range. For example, in terms of short range wireless networks, the communication network 165 can include a local wireless network built using Bluetooth or one of the IEEE 802 wireless communication protocols, i.e., 802.11a/b/g/i, 802.15, 802.16, 802.20, Wi-Fi Protected Access (WPA), or WPA2. In terms of long range wireless networks, the communication network 165 can include a mobile, cellular, and or satellite-based wireless network and support voice, video, text, and/or any combination thereof, i.e., GSM, TDMA, CDMA, and/or WCDMA network.

As shown, the information processing system 105 can include a messaging client 120 corresponding to an original sender 135 of an electronic message 170. The information processing system 110 can include a messaging client 125 corresponding to an additional sender 140 for the message 170. The information processing system 115 can include a messaging client 130 corresponding to a recipient 150 for the message 170. The messaging server 160 can communicate with each of the respective messaging clients 120-130 to facilitate the distribution, i.e., sending and receiving, of messages among the messaging clients 120-130.

It should be appreciated that fewer or more messaging clients can be included in the system 100. Additionally, messages can be sent from more than two senders and to more than one recipient if so desired. The particular number of recipients and senders, so long as a plurality of senders is specified, is not intended to limit the present invention. Further, those skilled in the art will appreciated that any of a variety of different computing systems can be used, e.g., mobile station, a personal digital assistant, etc., so long as the computing system is able to execute a messaging client and communicate with the communication network 165 as described herein.

In one arrangement, the messaging system, in reference to the messaging server 160 and corresponding messaging clients 120-130, can be implemented as an electronic mail system comprising a mail server and a plurality of electronic mail clients capable of sending electronic mail messages as described herein. In another arrangement, the messaging system can be implemented as an instant messaging system capable of exchanging instant messages as described herein. In still another arrangement, the messaging system can be implemented as an IP-based telephony system capable of exchanging and/or forwarding digitized voice messages to various networked nodes. Accordingly, as used herein, a “message” can include, but is not limited to, an electronic mail, an instant message, a text message, a Short Message Service (SMS) message, a voice mail, or any other message which may include an originator or “from” field specifying a sender and that can be sent to a recipient.

The messaging clients 120-130 can be configured to include multiple senders, or originators, within a “from” field, or an originator field, of a message, such as message 170, as well as display a message specifying multiple senders within the origination field. As used herein, an originator field, or originator portion of a message, can include, but is not limited to the “from” field, the “sender” field, and/or a “reply-to” field. The message 170, for example, can be distributed among the messaging clients 120 and 125 for approval by senders 135 and 140. Once approval is obtained from both senders 135 and 140, the message 170, with the senders 135 and 140 being specified in the originator portion of the message 170, can be sent to the messaging client 130 of the recipient 150.

The messaging clients 120-130 can be configured to implement a workflow to route the message 170 and obtain the needed approvals from various senders prior to sending any message specifying multiple originators to a recipient. In one embodiment, the messaging client 120 of the original sender 135 can specify a workflow responsive to receiving parameters, e.g., other senders, recipients, time limits for obtaining approval from other senders, editing permissions, and the like, from the original sender 135. The messaging client 120 can associate the workflow with the message 170. In one embodiment, the workflow can travel with the message 170. In another embodiment, the workflow, once specified, can be stored within the messaging server 160 and associated with the message 170 through the use of an identifier that can be included in the message 170. Accordingly, each messaging client that receives the message 170 can determine that the message 170 is associated with a workflow and communicate with the messaging server 160 to identify, obtain, and/or implement the workflow.

As used herein, a “workflow” can refer to a set of one or more tasks or actions that can be performed by any of a variety of different systems, where the systems may be software-based and/or hardware-based systems which may integrate with, or be controlled by, software. A workflow can be implemented by the messaging server 160, the messaging clients 120-130, or any combination thereof. A workflow can cause the messaging clients 120-130 and/or the messaging server 160 to perform one or more tasks automatically responsive to an event such as receiving a message that has been associated with a workflow.

In operation, the original sender 135, working through messaging client 120, can create message 170. The original sender 135 can specify one or more additional senders, such as additional sender 140. The messaging client 120 can send the message 170 to the messaging client 125 to obtain approval, such as a digital signature, from the additional sender 140. In one arrangement, the additional sender 140 can be permitted to make changes to the message 170 through the messaging client 125. In another arrangement, the additional sender 140 can be prohibited from making changes to the message 170 and only be permitted to accept or reject being added as a sender of the message 170. The sender 140 can provide input specifying approval and/or edits as the case may be through one or more user interface controls provided by messaging client 125.

Depending upon preferences established by the original sender 135, the message 170 can be sent back to the original sender 135 prior to being routed to the messaging client 130 of the recipient 150, or can be sent directly to the messaging client 130 of the recipient 150 from the messaging client 125 without first being routed back to the original sender 135.

In one embodiment, the original sender 135 can specify a time period in which approval from the additional sender 140 of the message 170 is to be obtained. For example, if a time period of 3 hours is specified by the original sender 135 as part of the workflow associated with the message 170, the additional sender 140 would need to provide any needed approval or other input, such as edits, if allowed, within that time frame.

If no approval is provided from additional sender 140, the message 170 can be provided back to the sender 135. The original sender 135 can determine whether to send the message 170 at all or as a conventional message where the additional sender 140 may or may not be listed in another field, i.e., a carbon copy field of the message. Regardless, the additional sender 140 is not included in the originator or sender portion of the message 170. In any case, until the needed approvals are obtained, the time allotted to obtain such approval expires, or the message 170 is otherwise finalized, the message 170 is not sent to any recipient or other person that may be carbon copied or blind copied. The message 170 can be said to be “finalized” when the workflow associated with that message finishes execution.

It should be appreciated that the functionality disclosed herein can be implemented through exploitation of extension points in applicable messaging RFCs. Accordingly, those messaging clients and/or messaging servers that do not implement the functionality disclosed herein still can process the messages associated with multi-sender functionality, albeit in a more conventional manner, i.e., without the ability to implement a workflow associated with the message or recognize multiple senders.

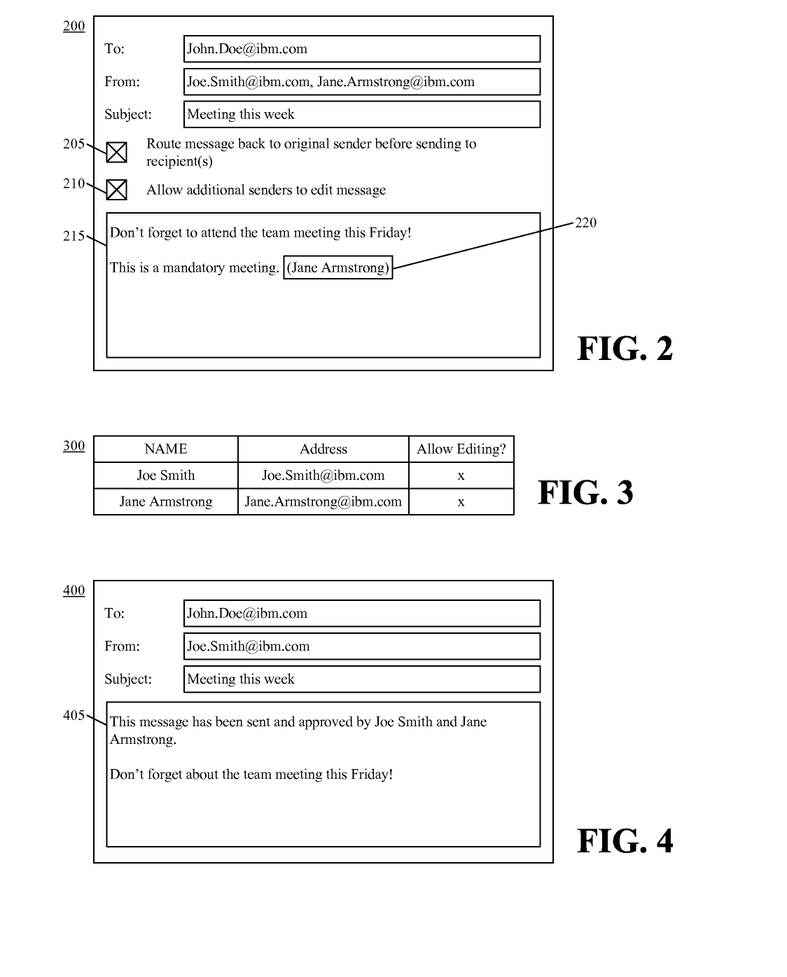

FIG. 2 is a view of a user interface 200 for presenting a message in accordance with another aspect of the present invention. The user interface 200 can be used by an original sender in composing a message to be sent from a plurality of senders. As shown, the original sender, who in this case can be Joe Smith having an address of “Joe.Smith@ibm.com”, has also specified that Jane Armstrong, having an address of “Jane.Armstrong@ibm.com”, is to be an additional sender. Accordingly, the address for Jane Armstrong is displayed within the “from” field of the message with the address for Joe Smith. The particular senders and recipients can be selected from an address book or other interface commonly used to select recipients for a message.

The user interface 200 further can include one or more controls that allow the original sender to specify how the message is to be handled. Selection of option 205 can cause the messaging system to send the message back to the original sender prior to delivering the message to the recipient. Thus, once Joe Smith, the original sender, composes the message and selects an option to route the message to the additional sender Jane Armstrong, the message will be delivered to Jane Armstrong for review. Once the additional sender provides approval, for example, through the messaging client of the additional sender or via another selection mechanism displayed within the message when opened, the message can be sent back to the messaging client corresponding to Joe Smith.

Selection of option 210 by the original sender will indicate whether the additional sender is permitted to make edits to the text of the message which reads “Don't forget to attend the team meeting this Friday!”. If option 210 is not selected, the additional user would be allowed only to provide permission, but no edits to the message. If allowed to make edits, the edits supplied by the additional user can be annotated to indicate such changes. When the message is delivered to the recipient, any changes made by Jane Armstrong can be marked or indicated when the message is opened. Those portions of the message from Joe Smith also can be indicated. For example, the body portion 215 of the message 200 includes an indication 220 that the text “This is a mandatory meeting” was added or included in the message 200 by Jane Armstrong. In one embodiment, the original sender of the message 200 can be indicated by being listed first in the “from” field of the message 200.

In an alternative embodiment, or based upon sender preference, edits need not be annotated. In any case, when the message is opened within the messaging client of the recipient, or the additional sender, the controls 205 and 210 can be hidden from view. Any options selected by the original sender can be stored as parameters of a workflow that is associated with, or included as part of the message. The workflow can be interpreted and enforced by messaging clients of the additional senders and the messaging server.

FIG. 3 is a view of a user interface 300 in accordance with another aspect of the present invention. The user interface 300 is an example of an address book type listing of available users that can be included as either senders or recipients. Further controls for specifying whether the address for a selected user will be inserted into a “carbon copy” field, a “from” field, or a “blind copy” field can be included as well. When used to specify senders of a message, the selection boxes in the column entitled “Allow Editing?” can be used to indicate, on a per user basis, whether a particular sender will be permitted to edit the message.

Further attributes can be presented and selected through the messaging clients. Selections made by the original sender can be incorporated into the workflow. For example, as noted, the original sender can impose a time period during which any additional senders for the message must respond with either edits, approval, or both edits and approval.

In another embodiment, the original sender can specify selected recipients that will be presented with a message specifying multiple senders. That is, though the message can be sent to a plurality of recipients, the original sender can specify that recipient A will see a message that is send from multiple senders, while recipient B will see a message that is sent from a single sender, with the other additional senders being listed in the carbon copy field rather than being listed in the sender field as for recipient A.

FIG. 4 is a view of a user interface 400 for presenting a message in accordance with another aspect of the present invention. The user interface 400 illustrates one way in which a message can be presented within a messaging client that does not support multiple sender functionality. For example, prior to delivering the message to the recipient, the messaging server can look up the recipient within an address book or other database to determine whether the recipient is using a multi-sender enabled messaging client. If so, the recipient can be presented with a view of the message that specifies the plurality of senders in the “from” field.

If the messaging client of the recipient is not multi-sender enabled, the messaging server can insert text or other indicators that the message has been sent from more than one sender and further indicate the senders. Thus, as shown, the body portion 405 of the message includes the text “This message has been sent and approved by Joe Smith and Jane Armstrong”. The text can be inserted within the message by the messaging server. Further, as the messaging client of the recipient does not support multi-sender messages, the “from” field can specify only one sender, in this case the original sender. In another embodiment, the sender listed from among multiple senders in the “from” field can be selected to be the sender in the most senior position as determined by examination of a corporate directory, e.g., an LDAP directory which includes corporate organizational information. Messaging clients that do not support multi-sender messages can simply ignore the attributes of the message that indicate multiple senders and the message can be presented as a conventional message, unless otherwise modified by the messaging server as shown. The text inserted into the body portion 405 can be interpreted by messaging clients that are not multi-sender enabled.

A multiple sender message received by a messaging client also can be forwarded to other users. The semantics associated with the message can be preserved such that when a user receives a multiple sender message forwarded from another user, the message can open and display the multiple senders as illustrated with reference to FIG. 2, assuming that the messaging client supports such functionality. Alternatively, if the messaging client does not support such functionality, the message can be presented as shown in FIG. 4.

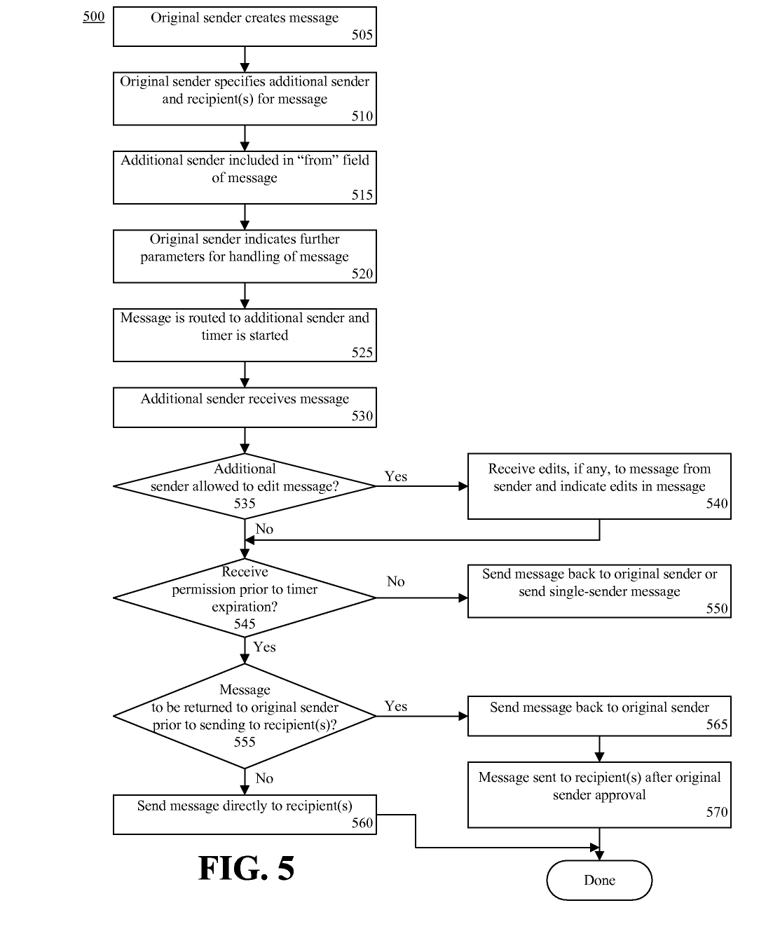

FIG. 5 is a flow chart illustrating a method 500 of generating an electronic message having multiple senders in accordance with another aspect of the present invention. The method 500 can be implemented using a messaging system comprising a messaging server and a plurality of messaging clients as described with reference to FIGS. 1-4. Though the method 500 is described with reference to including one additional sender, it should be appreciated that the techniques disclosed herein can be applied to cases where more than one additional sender is specified. Despite the number of senders, the original sender can remain the “owner” or the process. Thus, unlike other collaborative systems, the original sender can maintain sole control as to whether edits from other potential senders are incorporated or used in the message.

The method 500 can begin in step 505, where an original sender, working through his or her messaging client, creates or composes a message. In step 510, the original sender can specify an additional sender as well as one or more recipients for the message. The additional sender can be added to, or specified within, the “from” field or the originator portion of the message in step 515.

In another embodiment, the original sender can create a “blank check” type of message. In that case, the original sender can specify the additional sender to be included in the message, but need not specify any recipients for the message. Permission can be obtained from the additional sender well in advance of the message being sent or well in advance of the need even arising for the message to be sent. At some time in the future, having obtained the necessary permission, the original sender can send the message, for example, at a time of the original sender's choosing. Still, an expiration time period of the additional sender's permission can be applied to the message if so desired so that permission is not granted indefinitely.

It should be appreciated that in one embodiment, the content, or body, of the message and subject line can be locked, for example, after approval by the additional sender such that the original sender may only add one or more recipients to the message prior to sending. In another embodiment, the original sender can add text, remove text, or make any desired edits to the message body, subject, etc. In either case, when sent, the message can specify the original sender and the additional sender despite having obtained permission from the additional sender in the past, e.g., last week, last month, at the beginning of a project, or the like.

In step 520, the original sender can specify one or more parameters that dictate how the message is to be routed or handled within the messaging system. For example, the original sender can specify whether the message is to be provided back to the original sender after review, approval, and/or editing by the additional sender. The original sender further can indicate whether the additional sender is permitted to edit the message. The original sender also can specify a time period during which permission from the additional sender and/or edits to the message by the additional sender must be obtained.

In step 525, the message can be routed or sent to the additional sender specified by the original sender. For example, the message can be sent after the original sender is finished editing the message and chooses to distribute the message to the additional sender to obtain approval. The message, at this point, is not provided to any other recipients, whether such recipients are specified in a “to” field, a “carbon copy” field, or a “blind copy” field.

Additionally, in step 525, a timer can be started. In one embodiment, the timer can be started when the message is sent by the original sender. Starting the timer when the message is sent by the original sender can avoid the situation in which the additional sender is not available and, in consequence, the messaging client of the additional sender does not receive the message or does not receive the message in a timely fashion. For example, if the additional sender is not at work and the messaging client is not executing, the timer can be started irrespective of whether the additional sender has received the message. Still, in another embodiment, the timer can be started when the message is received within the messaging client of the additional sender. This option can be specified by the original sender as part of the parameters specified in step 520, for example. In any case, the timer can be set to the amount of time specified by the original sender for the additional sender to provide a response. It should be appreciated that the amount of time can be specified in terms of minutes, hours, or days, or further can be specified as a deadline, i.e., respond by Dec. 10, 2006 by 5:00 p.m., for example.

In step 535, the messaging client can determine, and indicate, whether the message can be edited by the additional sender. If so, the method can proceed to step 540. If not, the method can continue to step 545. In step 540, the additional sender can make any desired edits to the message. Once finished, the edits can be incorporated into the message and, optionally, annotated as belonging to the additional sender.

In step 545, a determination can be made as to whether permission from the additional sender has been received prior to expiration of the timer. If so, the method can proceed to step 550 where the message can be sent to the original sender. That is, if the time period in which the additional sender is to respond expires and no approval from the additional sender is received, the message can be provided back to the original sender automatically without the necessary permission to include the additional sender as a sender in the message. The original sender can discontinue any processing of the message or can choose to send the message to the recipients as a conventional message. For example, the additional sender can be included in the “carbon copy” field.

In another embodiment, an option can be provided that can be selected by the original sender which causes the message to be provided to the recipients automatically upon expiration of the timer. In that case, if the additional sender does not provide permission within the allotted amount of time, the additional sender can be added to a “carbon copy” field and the message can be routed to the recipients as a single-sender message, i.e., a message with one sender.

It should be appreciated that the timer checking steps disclosed herein are for illustrative purposes. Those skilled in the art will recognize that a timer can be set and started. Upon expiration of that timer, the processing within the messaging client of the additional sender can be interrupted to implement the functionality disclosed herein. As such, the particular point or points when the timer is checked, as represented in FIG. 5, are not intended to limit the present invention or to suggest a particular point that the time must be checked. The timer can be checked continually such that upon expiration, one or more actions, as determined by the workflow associated with the message, are performed. By the same token, if permission is provided by the additional sender prior to expiration of the timer, further processing and/or routing of the message can continue without waiting for the expiration of the timer.

In any case, if permission is received from the additional sender prior to expiration of the timer, the method can proceed to step 555. In step 555, the messaging client of the additional sender can determine whether the message is to be routed back to the original sender or provided directly to the recipient(s). If the message can be provided directly to the recipient(s), the method can proceed to step 560. In step 560, the messaging client of the additional sender can send the message to the recipient after receiving an input from the additional sender that is indicative of approval or that the additional user is finished editing the message.

If the message is to be provided back to the original sender, the method can proceed to step 565. In step 565, the message can be sent back to the original sender after the additional sender is finished editing the message and/or provides approval. In step 570, the original sender can accept or reject modifications to the message that may have been made by the additional senders. In any case, once the original sender provides an input indicating approval, the message can be sent to the recipient from the messaging client of the original sender. It should be appreciated that despite the location from which the message is sent, the message can include the original sender and the additional sender in the “from” field of the message.

The embodiments disclosed herein relate to including multiple senders within a message. As noted, the embodiments disclosed herein can be incorporated into electronic mail systems, instant messaging system, text messaging systems, voice mail systems, and the like. In one embodiment, the ability to include additional senders can be extended to calendar invitations and/or to-do's. Such messages can be routed among potential senders and ultimately delivered to a recipient where more than one sender is specified for the calendar invitation or to-do.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A method of specifying a plurality of senders for a message comprising:
creating a message associated with a first sender;
associating a second sender with the message;
specifying the first sender and the second sender in an originator portion of the message; and
sending the message to a recipient.

2. The method of claim 1, further comprising:
sending the message to the second sender; and
receiving approval from the second sender prior to sending the message to the recipient.

3. The method of claim 1, further comprising:
determining whether approval from the second sender is received within a predetermined time period; and
if not, routing the message back to the original sender without sending the message to the recipient.

4. The method of claim 1, further comprising:
determining whether approval from the second sender is received within a predetermined time period; and
if not, sending the message to the recipient as a single-sender message.

5. The method of claim 1, further comprising:
receiving a modification to the message from the second sender; and
sending the modified message to the recipient.

6. The method of claim 1, further comprising:
receiving a modification to the message from the second sender; and
sending the modified message back to the first sender prior to sending the message to the recipient.

7. The method of claim 1, further comprising:
receiving a modification to the message from the second sender; and
sending the message to the recipient without first routing the message back to the first sender.

8. The method of claim 1, further comprising selectively allowing a change to the message from the second sender according to a parameter set by the first sender.

9. The method of claim 1, further comprising inserting into the message an indication that is interpretable by a messaging client that is not multi-sender enabled that the message is sent from both the first sender and the second sender.

10. The method of claim 1, wherein the message is sent to a plurality of recipients, the method further comprising:
presenting the message as a multi-sender message in a messaging client corresponding to a first of the plurality of recipients; and
presenting the message as a single-sender message in a messaging client corresponding to a second of the plurality of recipients.

11. A system for specifying a plurality of senders for a message comprising:
a first messaging client associated with a first sender, wherein the first messaging client creates a message from the first sender and associates the message with a second sender;
a second messaging client associated with the second sender, wherein the first messaging client sends the message to the second messaging client and the second messaging client provides approval of the message; and
a messaging server providing the message to a recipient, wherein the message specifies the first sender and the second sender within an originator portion of the message.

12. The system of claim 11, wherein the first messaging client associates the message with a time period during which approval from the second messaging client must be received.

13. A computer program product comprising:
a computer-usable medium having computer-usable program code that specifies a plurality of senders for a message, said computer program product including:
computer-usable program code that creates a message associated with a first sender;
computer-usable program code that associates a second sender with the message;
computer-usable program code that specifies the first sender and the second sender in an originator portion of the message; and
computer-usable program code that sends the message to a recipient.

14. The computer program product of claim 13, further comprising:
computer-usable program code that sends the message to the second sender; and
computer-usable program code that receives approval from the second sender prior to sending the message to the recipient.

15. The computer program product of claim 13, further comprising:
computer-usable program code that determines whether approval from the second sender is received within a predetermined time period; and
computer-usable program code that routes the message back to the original sender without sending the message to the recipient if approval is not received within the predetermined time period.

16. The computer program product of claim 13, further comprising:
computer-usable program code that determines whether approval from the second sender is received within a predetermined time period; and
computer-usable program code that sends the message to the recipient as a single-sender message if approval is not received within the predetermined time period.

17. The computer program product of claim 13, further comprising:
computer-usable program code that receives a modification to the message from the second sender; and
computer-usable program code that sends the modified message to the recipient.

18. The computer program product of claim 13, wherein the message is sent to a plurality of recipients, the computer-usable medium further including:
computer-usable program code that presents the message as a multi-sender message in a messaging client corresponding to a first of the plurality of recipients; and
computer-usable program code that presents the message as a single-sender message in a messaging client corresponding to a second of the plurality of recipients.

19. The computer program product of claim 13, further comprising computer-usable program code that selectively allows a change to the message from the second sender according to a parameter set by the first sender.

20. The computer program product of claim 13, further comprising computer-usable program code that inserts into the message an indication that is interpretable by a messaging client that is not multi-sender enabled that the message is sent from both the first sender and the second sender.
